(19) United States
(12) Patent Application Publication
(10) Pub. No.: US 2010/0262986 A1
(43) Pub. Date: Oct. 14, 2010

(54) VIEWING HISTORY

(75) Inventors: Venkata S. Adimatyam, Irving, TX (US); Daksh Jasra, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Patent And Licensing Inc., Basking Ridge, NJ (US)

(21) Appl. No.: 12/420,522

(22) Filed: Apr. 8, 2009

(51) Int. Cl. H04H 60/33; H04N 7/173; H04N 5/445

(52) U.S. Cl. 725/9; 725/134; 725/40

(57) ABSTRACT

A method may include capturing descriptive information associated with viewed television content as it is being viewed. The captured information may be stored. A request to display viewing history information may be received. At least some of the captured information may be retrieved and displayed.

### BACKGROUND

Personal entertainment options, such as television-based programs, are becoming more plentiful and accessible. Furthermore, convergence of media options are making it increasingly possible for a single distribution device, such as a set top box or media center computing device, to deliver many different types of television content, such as live television, recorded television, on demand movies, games, Internet browsing, etc., in an easy to user manner.

### BRIEF DESCRIPTION OF THE DRAWINGS

FIG. 1 depicts a diagram of an exemplary network in which systems and methods described herein may be implemented;

FIG. 2 illustrates exemplary components of a set-top box (STB), television, server, and/or user device of the network depicted in FIG. 1;

FIG. 3 is an exemplary functional block diagram of components implemented in the STB of FIG. 1;

FIG. 4 illustrates a structure of an exemplary database for storing viewing history metadata information captured by the metadata capture logic of FIG. 3;

FIGS. 5 and 6 are diagrams of exemplary user interfaces capable of being generated by the STB and/or the server of the network illustrated in FIG. 1;

FIGS. 7 and 8 illustrate flow charts of exemplary processes according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to devices, methods, and systems for facilitating capturing and reviewing of television content viewing history information. In some implementations, a set-top box (STB), a display device (e.g., a television), or another electronic device may collect and store information relating to viewed television content. The collected information may include various details relating to the television content, such as type (e.g., live, recorded (e.g., via a digital video recorder (DVR) or a multi-room DVR), video on demand (VOD), video games, etc.), genre of programming, (e.g., kids, action, drama, comedy, sports, etc.), program names, etc. In general terms, the collected information may be defined as metadata corresponding to viewing activity.

Once collected, the stored viewing history information may be presented to a user in a variety of manners, such as a timeline view, a menu-driven view, or other types of graphical viewing options. In addition, in some implementations, viewing habits or viewing history information for a number of different display devices or individual viewers (or groups of users) may be maintained and made available to a user associated with each display device or individual (e.g., an account hold, a homeowner, etc.). In some implementations, review of viewing history information may inform users regarding the type and duration of content viewed. This information may be used to identify user preferences for the purposes of selecting programming options, etc. In additional implementations, the collected viewing history information may be used, e.g., by a video programming service provider, to subsequently suggest or automatically record television content for one or more viewers.

As used herein, the terms “viewer” and/or “user” may be used interchangeably. Also, the terms “viewer” and/or “user” are intended to be broadly interpreted to include a user device, a STB, and/or a television or a user of a user device, STB, and/or television.

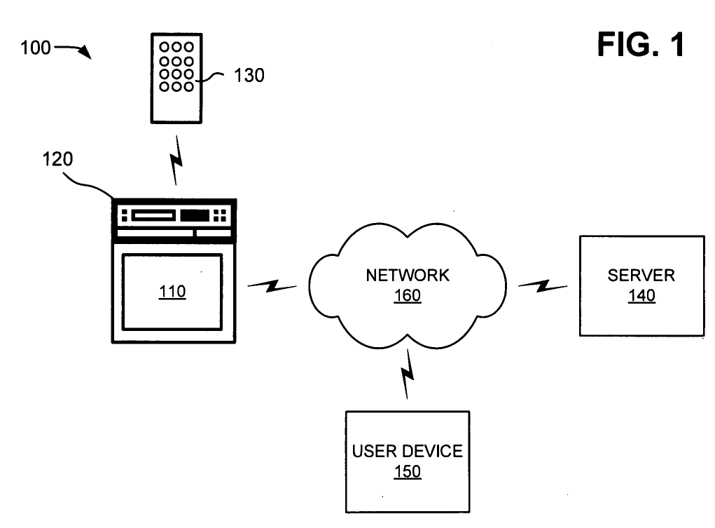

FIG. 1 is a diagram of an exemplary network 100 in which systems and methods described herein may be implemented. As illustrated, network 100 may include a television (TV) 110, a STB 120, a remote control 130, a service provider 140, and a user device 150 interconnected by a network 160. Components of network 100 may interconnect via wired and/or wireless connections. A single television 110, STB 120, remote control 130, service provider 140, user device 150, and network 160 have been illustrated in FIG. 1 for simplicity. In practice, there may be more televisions 110, STBs 120, remote controls 130, service providers 140, user devices 150, and/or networks 160. Also, in some instances, one or more of the components of network 100 may perform one or more functions described as being performed by another one or more of the components of network 100.

Television 110 may include any suitable display device capable of displaying television programming, content provided by STB 120, and/or content provided by other devices (e.g., a digital video disk (DVD) player, a video camera, a home media player, etc., not shown) connected to television 110.

STB 120 may include a device that receives television programming (e.g., from service provider 140), and provides the television programming to television 110 or another device. STB 120 may allow a user to alter the programming provided to television 110 based on a signal (e.g., a channel up or channel down signal, etc.) from remote control 130. In some implementation consistent with aspects described herein, STB 120 may record video in a digital format to a disk drive or other memory medium within STB 120. In one exemplary implementation, features of STB 120 may be incorporated directly within television 110.

Remote control 130 may include a device that allows a user to control programming and/or content displayed on television 110 via interaction with STB 120. Furthermore, remote control 130 may facilitate interaction with various television viewing history features associated with STB 120.

Service provider 140 may include one or more server entities, or other types of computation or communication devices, that gather, process, search, and/or provide information in a manner described herein. In one implementation, service provider 140 may include a server (e.g., a computer system or an application), a cable head-end, or a broadcaster capable of providing content (e.g., TV programming, movies, on-demand services, live television, news feeds, blog feeds, etc.), advertisements, instructions, codes, encryption keys, and/or other information associated with products and/or services, etc., to STB 120. In some implementations, service provider 140 may be configured to receive information from STB 120, television 110, or user device 150 in the manner described below.

User device 150 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop or notebook computer, a personal computer, an ultra mobile personal computer (UMPC), a netbook, or other types of computation or communication devices, threads or processes running on these devices, and/or objects executable by these devices. In one implementation, user device 150 may include any device (e.g., an Internet Protocol (IP)-based device) that is capable of accessing service provider 140 via network 160. In other implementations, user device 150 may be configured to interact with STB 120 or television 110, via a local network different than network 160 (e.g., a home wired or wireless network).

Network 160 may include a local area network (LAN), a wide area network (WAN), a metropolitan area network (MAN), a telephone network, such as the Public Switched Telephone Network (PSTN), an intranet, the Internet, an optical fiber (or fiber optic)-based network, or a combination of networks.

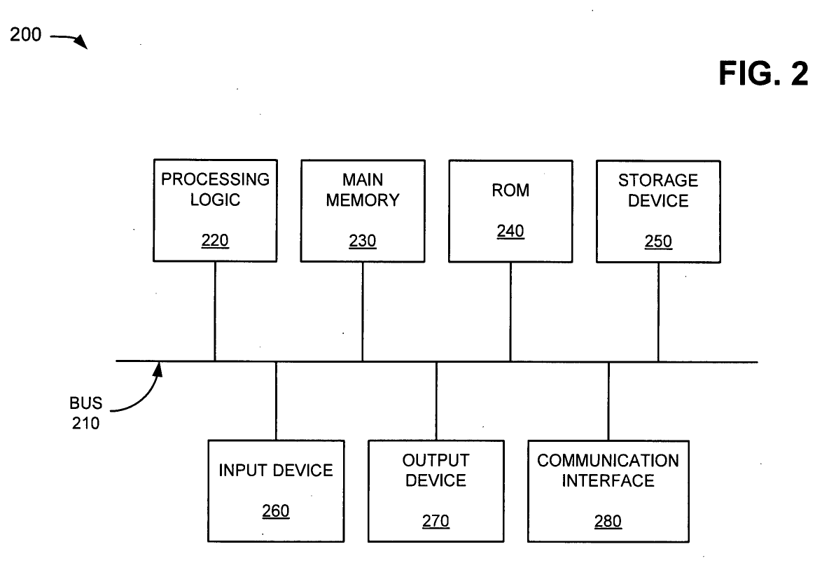

FIG. 2 is an exemplary diagram of a device 200 that may correspond to any of STB 120, service provider 140, and/or user device 150. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, remote control 130, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 160.

As described herein, device 200 may perform certain operations in response to processing logic 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

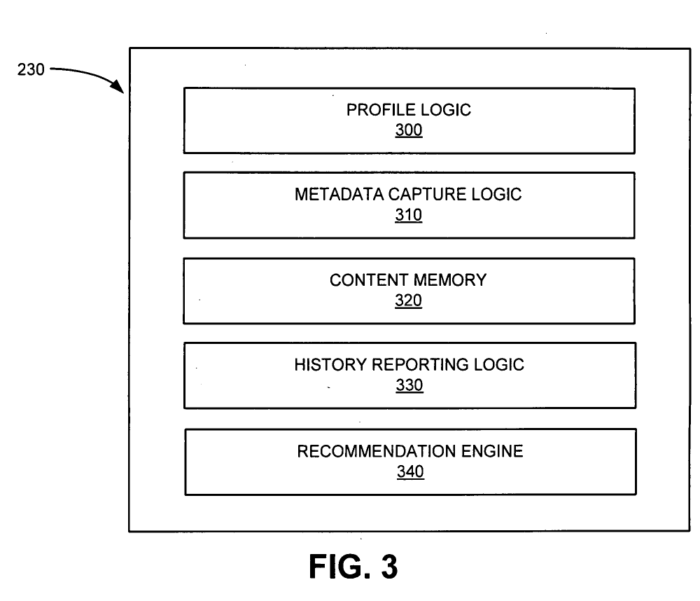

FIG. 3 is an exemplary functional block diagram of components implemented in STB 120 and/or television 110 of FIG. 1. In an exemplary implementation, all or some of the components illustrated in FIG. 3 may be stored in memory 230. For example, referring to FIG. 3, memory 230 may include profile logic 300, metadata capture logic 310, content memory 320, history reporting logic 330, and recommendation engine 340. In addition, various logic components illustrated in FIG. 3 may be implemented by processing logic 220 executing one or more programs stored in memory 230.

Profile logic 300 may include may include logic configured to receive information corresponding to monitoring or capturing television viewing information associated with one or more user devices (e.g., television 110 or STB 120). For example, profile logic 300 may be configured to receive viewing history profile information from one or more users of the STB 120, such as an account holder associated with STB 120. Exemplary viewing history profile information may include at least an identifier corresponding to television viewers associated with the established profile. For example, different viewing history profiles may be associated with different types of television viewers, such as adults, children (or a particular child), guests, etc. Viewing history profile information may also include rules that define the type of viewing information to be captured, the manner in which captured information is presented to a reviewing user, and/or the duration that the captured information is retained for subsequent review.

In some implementations, the viewing history profile information may be explicitly received from a user, such as an account holder. For example, profile logic 300 may provide an interface (e.g., an on screen display (OSD), web server, interactive voice response system, call center, etc.) for receiving viewing history profile information from a user. Such an interface may query the user for viewing history profile information hierarchically based on information that has been previously submitted. For example, in an OSD implementation, an initial set of questions may be provided regarding the viewing history profile to be set up, such as the age (or age group) of the person being monitored, etc. Follow-up questions may then be presented that are tailored based on responses to the initial set of questions. For example, when a minor child age group has been entered, the user may be subsequently queried about capturing adult-themed content information (e.g., based on rating, description, channel, etc.).

In some implementations, viewing history profile information may include only a name designation (e.g., a name of an individual user associated with the profile or a designation associated with a group of users, e.g., “family,” or “kids”), with comparable information being captured and stored for each defined profile. An authorized user (e.g., an account holder) may review the information collected for each profile.

Metadata capture logic 310 may include logic configured to capture, receive, or otherwise obtain data relating to television content viewed on television 110, e.g., via STB 120. In some implementations, metadata capture logic 310 may be configured to capture and store information associated with television content as it is viewed on, e.g., television 110. In one exemplary implementation, STB 120 may be configured to periodically receive content description information (referred to herein as “program guide information”) from service provider 140 (e.g., a broadcaster, cable company, etc.) relating to television programming available for viewing. The received program guide information may include scheduling and descriptive information relating to content to be received by STB 120 for a predetermined period of time. For example, STB 120 may receive updated program guide information on an hourly or daily basis.

The program guide information may be provided to a user, upon command, as a program guide or menu. In one implementation, the program guide may include a generally grid-like arrangement of the program guide information corresponding to a selected time slot. Selection of a particular program displayed in the program guide may result in STB 120 immediately navigating to the selected channel, or, for future programming, may trigger an inquiry regarding whether the user wishes to set STB 120 to change channels at the program time, or record the program via STB 120's DVR functionality.

In one implementation, the received program guide information may associate program data based on channel identifiers associated with received programming data. For example, the received program guide information may include an entry indicating that “Judge Judy” is broadcast on channel 404 from 4:00 PM to 4:30 PM on Mar. 3, 2009. The program guide information entry may also include additional program information, such as genre, rating, a brief plot synopsis, etc. STB 120 may store this information (e.g., in a table or other suitable memory structure). In the event that a user either directly views (i.e., tunes into) or records (for future viewing) channel 404 during the identified time slot, STB 120 may determine that the user has watched at least a portion of the “Judge Judy” program. For recorded content, the program guide information corresponding to the recorded program may be stored and associated with the recorded program, in order to provide identification information to the user.

Consistent with embodiments described herein, metadata capture logic 310 may be configured to track or otherwise capture the program guide information associated with viewed programming, the times, durations, and the manners in which the programming was viewed, and a profile identifier associated with the viewer. For example, assume that a member of the “kids” profile has activated STB 120 and identified themselves as a member of the “kids” profile (e.g., by logging in, selecting “kids” from a listing of available profiles, etc.). In this instance, the “kids” profile would be active on STB 120. Further assume that STB 120 has received updated program guide corresponding to viewable television content. STB 120 may receive a selection of a particular channel number, either by direct input (e.g., via a remote control) or by user interaction with the program guide interface. STB 120 may navigate to the requested program.

In another example, assume that a user account with a service provider 140 includes two or more STB's 120. For example, the user may have a first STB 120 connected to a first television 110 in the basement, a second STB 120 connected to a second television 110 in the family room, and a third STB 120 connected to a third television 110 in the bedroom. Consistent with embodiments described herein, metadata capture logic 310 may be configured to capture information regarding viewed content across all STB's 120 associated with a user account.

In addition, two or more of STB's 120 may be configured to provide multi-room recording or multi-room DVR. Multi-room DVR refers to a feature in which a user may watch a portion of recorded content in one room (e.g., via a first STB 120). The user may then stop playback of the programming content on the first STB 120 and, at some point in the future, continue playback of the programming on a second STB 120 associated with the user's account, picking up where the user stopped watching at the first STB 120. In other words, DVR content recorded and stored on a particular STB 120, but playback of the content may not be limited to the STB 120 on which it was recorded. Rather, the content may be streamed or otherwise transmitted to other STB's 120 associated with the user's account. In some implementations, such STB's 120 may be geographically diverse from each other, with transmission of content occurring via network 160.

In this implementation, metadata capture logic 310 may be further configured to capture information relating to multi-room DVR viewing, such as location identifiers relating to where the content was viewed, percentages of time viewed in each location, etc.

Consistent with implementations described herein, metadata capture logic 310 may track the viewing experience by storing program guide information corresponding to the selected channel number and time slot and the start time of the viewing e.g., as an entry in content memory 320. For previously recorded content, metadata capture logic 310 may store the program guide information previously stored with the recorded content. If/when the user changes channels, metadata capture logic 310 may store a stop time in the entry corresponding to the previously viewed content and may store the program guide information corresponding to the newly selected channel number and time slot and the start time of the current viewing. The start and stop times may be used to calculate total viewing times during subsequent reporting of the viewing history. In one exemplary implementation, content viewing for a period of time below a defined threshold, such as 1 minute, may be disregarded to account for channel surfing behaviors, mis-entered channel numbers, etc.

Content memory 320 may include one or more memories, such as a hard disk drive (HDD), solid state drive (SSD), random access memory (RAM), read only memory (ROM) or another memory that stores the above-described metadata upon capture by metadata capture logic 310. For example, in one implementation, content memory 320 may include a database of entries corresponding to captured metadata. In one implementation, each entry in the database may include a profile identifier, content name, content description, type, genre, rating, start time, stop time, and duration. Additional types of captured metadata may include actor identifications, director identifications, producer identifications, graphical elements, such as channel logos, movie posters, etc. Further, for accounts having more than one STB 120, captured metadata may include an STB identifier, or more than one identifier for multi-room DVR content. The stored metadata may facilitate reviewing of the metadata and/or reporting based on the metadata at a later time, as described in detail below.

History reporting logic 330 may include logic configured to receive a request for viewing history information from an authorized user, e.g., an account holder or household adult. As will be described in additional detail below, the request for viewing history information may be received via a graphical user interface (GUI) associated with STB 120 and/or television 110. In other implementations, the request for viewing history information may be received from user device 150, via network 160.

Although illustrated as part of STB 120 or television 110, in an alternative implementation, content memory 320 may include a memory structure remote from STB 120 or television 110, such as a remote database, web server, or the like. For example, content memory 320 may be stored at a remote server configured to periodically receive viewing history information from STB 120 via a network, such as network 160. In such an implementation, history reporting logic 330 may include a web server application configured to provide a web interface for facilitating receipt of the request for viewing history information via network 160 or other suitable data network.

Regardless of the manner in which the receipt for viewing history information is received, history reporting logic 330 may be configured to initially determine whether the request has been received from an authorized user, prior to providing the viewing history information. When it has been determined that the request has been received from an authorized user, history reporting logic 330 may be configured to provide viewing history information in a variety of formats. In some implementations, the viewing history information may be provided for an identified profile or profiles associated with the user. Alternatively, the viewing history information may be provided for all profiles associated with the user.

As will be discussed in additional detail below, in one implementation, viewing history information may be provided in a hierarchical manner, beginning with an initial overview presentation of recent viewing history. For example, history reporting logic 330 may retrieve captured metadata corresponding to one or more profiles from content memory 320. History reporting logic 330 may generate an overview viewing history presentation (e.g., a web page or an OSD screen) that includes overview historical viewing information, such as percentages (or discrete amounts) of time associated with particular categories (e.g., genres, content types, etc.) of television content. For example, an overview viewing history display associated with a “kids” profile may indicate that, for a defined period of time, users associated with the “kids” profile watched live television content 70% of the time, watched recorded television content 20% of the time, and watched video on demand (VOD) content 10% of the time. This display may be referred to as a “Category” display. Additionally, the overview display may indicate that the users associated with the “kids” profile watched “children's” programming 30% of the time, “comedy” programming 30% of the time, “family” programming 20% of the time, and “action/adventure” programming 20% of the time. This display may be referred to as a “Content Information” display.

The time period used to calculate the presented viewing history information may be explicitly received from the user at the time the request is made. Alternatively, the time period used to calculate the presented viewing history information may be a default time period, such as a month, a week, etc. In some implementations, the time period may initially be set at a default value, but may be modified during a viewing history session as specific by the user.

As discussed above, the display of viewing history information may be based on the retrieved metadata information stored in content memory 320. This information may be hierarchically presented, such that the user may navigate to or select an element of presented information to identify additional information relating to the selected element. For example, the user may navigate to the element indicating that “action/adventure” programming was viewed 10% of the time. Selection of this element may result in display of the metadata information corresponding to this element. For example, selection of the element indicating that “action/adventure” programming was viewed 10% of the time may result in a display of additional details regarding the viewed content corresponding to the “action/adventure” genre for the specified time period. The additional details may include information such as the viewed content name, rating, time viewed, etc.

In addition to basing viewing history information on content types or genres, alternative implementations may display viewing history information based on programming title (e.g., movie title or tv show title, etc.), actors names, viewing methodology (uninterrupted, multi-room, unfinished, etc.), etc. For example, the viewing history information may be presented based on programming title (e.g., 20% “Friends,” 10% “Everybody Loves Raymond,” 30% “Oprah,” and 40% “Family Guy”). In another example, the viewing history information may indicate that 50% of the watched movies starred Tom Cruise.

In one exemplary implementation, viewing history information may be presented in a timeline view, enabling a reviewing user to view a timeline of programming content viewed during a particular time period. For example, assuming that the selected or default time period is one month, the display of viewing history information may include a one-month timeline that depicts the viewing experience associated with the profile for the past month. In one implementation, multiple timeline views may be provided, each corresponding to a different type or category of viewed content. Alternatively, a single timeline may be provided depicting viewing across all types.

Depending on the amount of programming viewed during the interval, more or less information may be presented in the timeline. When a large amount of viewing has occurred, a relatively lower amount of information may be provided and vice-versa. This dynamic display of information may account for screen size and resolution associated with the display of information. For example, when a large amount of viewing has occurred for a particular category, the timeline view may include brief descriptive information corresponding to the viewing history, such as percentages of viewed content types for each day in the timeline (e.g., 10% VOD, 60% live TV, 30% DVR).

The user may be able to navigate to and “drill down” into any specific timeline entry. For example, the day listed above may be drilled down into, resulting in display of a one day timeline view. Given the relatively lower amount of information corresponding to only a single day (as compared to an entire month), the displayed one day timeline view may provide more information, such as identifiers (e.g., titles) associated with the content viewed throughout the day.

The user may be able to select an entry in the one day timeline to display additional information, such as specific times viewed, rating, description, etc. This may enable individuals to accurately identify the type and duration of television content consumed by users associated with a particular profile.

Recommendation engine 340 may include logic configured to identify suggested content options based on the captured viewing history information stored in content memory 320. For example, recommendation engine 340 may be configured to determine viewing preferences associated with a profile and make suggestions regarding future programming or viewing plan options based on the stored viewing history information. As an example, assume that the stored viewing history information indicates that users associated with a profile have recently viewed comedy VOD offerings starring Jack Black. Recommendation engine 340 may determine that the users associated with the profile may be interested in ordering a new offering starring Jack Black that is available for subsequent viewing. This suggestion may be presented to users associated with the profile via, for example, a “Suggestions” menu option, or via a message displayed upon login to STB 120 or television 110.

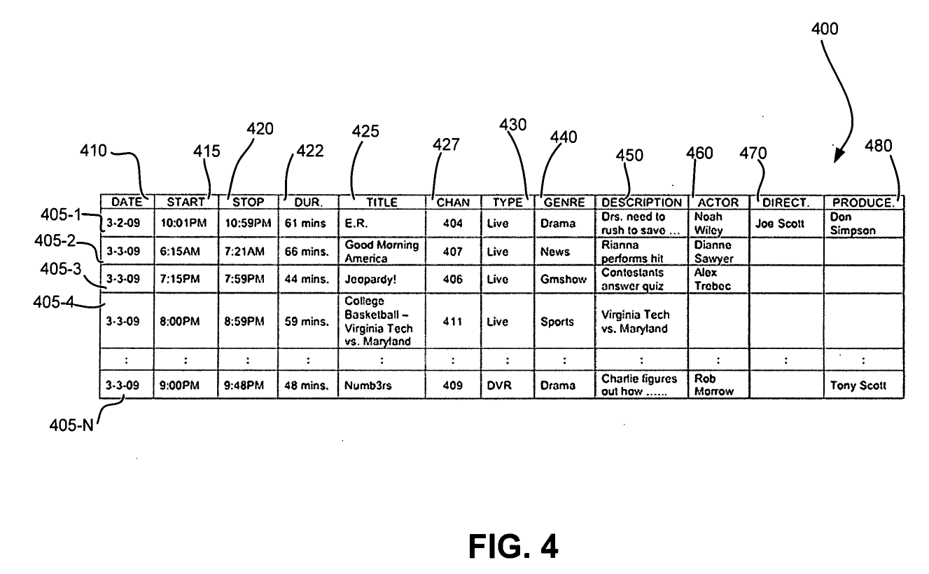

FIG. 4 illustrates a structure of an exemplary database 400 for storing captured programming metadata information received by metadata capture logic 310. Database 400 may be stored in content memory 320. Referring to FIG. 4, database 400 may include a number of content viewing entries 405-1 to 405-N (collectively “entries 405” or individually “entry 405”). Each entry 405 corresponds to a period of viewing activity corresponding to an associated monitoring profile. Although only a single profile is depicted in database 400 it should be understood that database 400 would typically include information for a number of profiles associated with a particular account (e.g., a household).

In an exemplary embodiment, each content viewing entry 405 may include a date field 410, a start time field 415, a stop time field 420, a duration field 422, a title field 425, a channel field 427, a type field 430, a genre field 440, a description field 450, an actor field 460, a director field 470, and a producer field 480. As described above, metadata capture logic 310 may receive or otherwise obtain metadata information corresponding to viewed television content. Additionally, each field 410-480 in entries 405 may include a plurality of fields. For example, actor field 460 may include a plurality of fields, each including the name of an actor appearing in the content.

Date field 410 may include an identifier corresponding to the date on which the content was viewed. Start time field 415 may include a value indicating when viewing of the content began (e.g., 7:50 PM, 4:05 PM, etc.). In some implementations, multiple viewings of a single content (i.e., program) may be captured in different content viewing entries 405. Alternatively, a single viewing entry 405 corresponding to the single content may be updated to reflect multiple viewing sessions, e.g., by including multiple start times in start time field 415. Stop time field 420 may include a value indicating when viewing of the content stopped. As mentioned above, for multiple viewing sessions of a single content, stop time field 420 may include multiple stop times, each stop time corresponding to a start time in start time field 415. Duration field 422 may include a value corresponding to the total viewing time for the content entry. The value in duration field 422 may be calculated based on the value(s) in start time field 415 and stop time field 420.

Title field 425 may include information corresponding to the title of the viewed content. Type field 430 may include information corresponding to the type of viewed content (e.g., live television, recorded television, video game, VOD purchase, widget, etc.). Channel field 427 may include information corresponding to the channel number of the viewed content. Genre field 440 may include information corresponding to the genre assigned to the viewed content in the program guide (e.g., drama, action, comedy, family, children's, adult, etc.). Description field 450 may include a value corresponding to the description assigned to the viewed content in the program guide. Typically, the description includes a short plot synopsis that corresponds to the content. Actor field 460 may include information corresponding to names of actors appearing in or associated with the viewed content. Director field 470 may include information corresponding to the name of the director associated with the viewed content. Producer field 480 may include information corresponding to the name of the producer associated with the viewed content. It should be understood that the above metadata fields are exemplary only and suitable information associated with viewed content may be similarly captures, such as content ratings, review information, video format information (e.g., High Definition, 3D, etc.). In one implementation, the values of title field 425, genre field 440, description field 450, actor field 460, director field 470, and producer field 480 may be retrieved from the program guide information received by STB 120 or television 110.

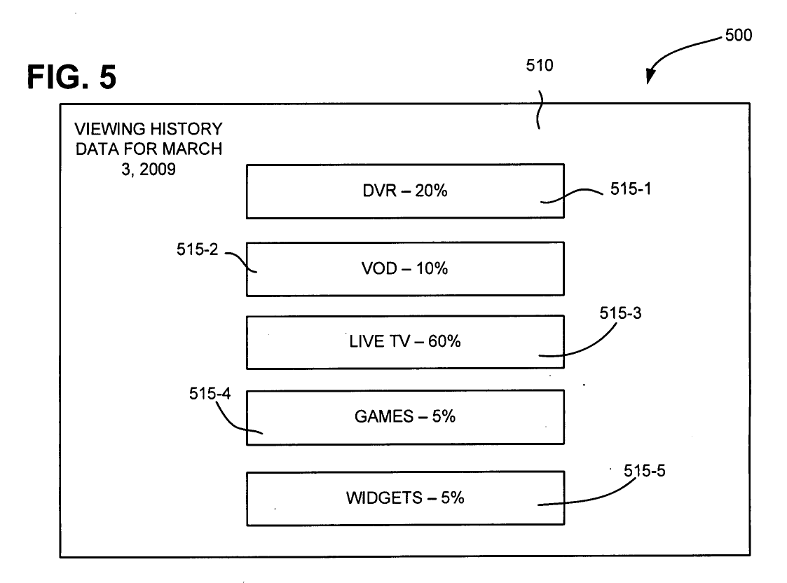

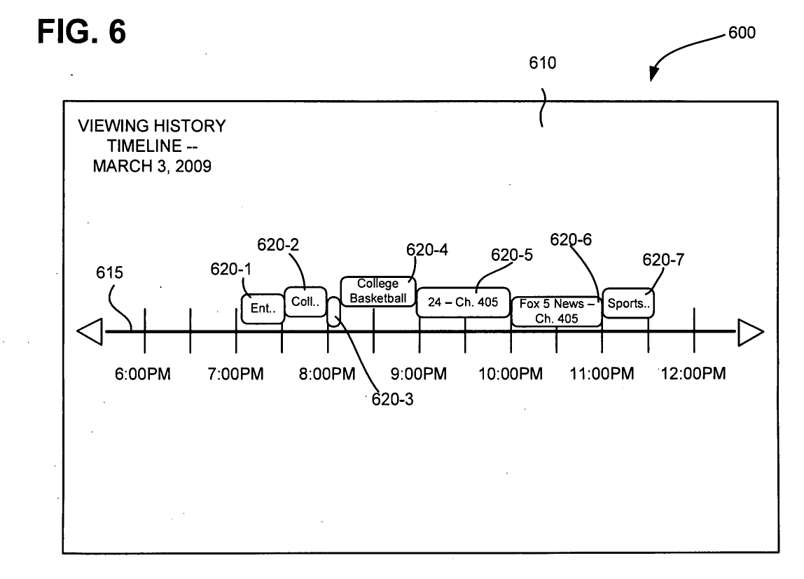

FIG. 5 illustrates a diagram of an exemplary user interface 500 capable of being generated by television 110, STB 120, and/or service provider 140 (e.g., and displayed via television 110). The user interface depicted in FIG. 5, and the user interface depicted in FIG. 6 and described below (collectively referred to as “the user interfaces”), may include a graphical user interface (GUI) or a non-graphical user interface, such as a text-based interface. The user interfaces may provide information to users via a customized interface (e.g., a proprietary interface) and/or other types of interfaces (e.g., a browser-based interface, a television interface, etc.). The user interfaces may receive user inputs via one or more input devices (e.g., input device 260), may be user-configurable (e.g., a user may change the size of the user interfaces, information displayed in the user interfaces, color schemes used by the user interfaces, positions of text, images, icons, windows, etc., in the user interfaces, etc.), and/or may not be user-configurable. The user interfaces may be displayed to a user via one or more output devices (e.g., output device 270).

As illustrated in FIG. 5, user interface 500 may include a viewing history overview screen 510. As described above, viewing history overview screen 510 may include a number of textual or graphical elements or items 515-1 to 515-5 (collectively “elements 515” or individually “element 515”) corresponding to types or other categories of television content viewed over a defined time period. In the example of FIG. 5, elements 515 correspond to types of television content and include DVR (element 515-1), VOD (element 515-2), live television (element 515-3), games (element 515-4), and widgets (element 515-5). As further illustrated in FIG. 5, each element 515 may indicate the percentage of time spent viewing the corresponding type of television content. For example, element 515-1 indicates that DVR (i.e., recorded) content was viewed 20% of the time, element 515-2 indicates that VOD content was viewed 10% of the time, element 515-3 indicates that live television was viewed 60% of the time, element 515-4 indicates that games content was viewed (or played) 5% of the time, and element 515-5 indicates that widgets content (e.g., weather, stock quotes, news feeds, etc.) was viewed 5% of the time. In other implementations, elements 515 may correspond to other categories of content, such as genres, content titles, actors' names, etc.

User interface 500 may be configured to enable a user to request additional information relating to any of elements 515, e.g., in a drill-down manner. For example, STB 120 may receive commands from a remote control associated therewith (e.g., remote control 130), to navigate to and select element 515-3. Selection of live television element 515-3 may result in user interface 500 displaying additional details regarding the live television viewing content, such as specific information regarding content viewed, times viewed, etc.

As described above, viewing history information may alternatively be presented in a timeline view for graphically depicting a viewing experience corresponding to a selected profile. Further, as described above, the timeline view may depict viewing history information corresponding to a defined subset of all viewing history information, such as a particular period of time, a particular type of viewing content, etc. In some implementations, a timeline view may include a summary timeline including content similar to that described above with respect to FIG. 5 using category/type labels.

FIG. 6 illustrates a diagram of an exemplary user interface 600 capable of being generated by television 110, STB 120, and/or service provider 140. User interface 600 may include a viewing history timeline screen 61 0. As described above, viewing history timeline screen 610 may include a timeline element 615 and a number of content markers 620-1 to 620-7 (collectively “content markers 620” or individually “content marker 620”) positioned on timeline element 615. Each content marker 620 corresponds to a viewing period for viewed program. For example, timeline element 615 depicts a timeline display for live television content for Tuesday, Mar. 3, 2009 from 6:00 PM to 12:00 PM.

Selection of the timeline viewing interval may be made in any suitable manner. For example, an initial display may cover the default time period for viewing history timeline screen 610. Alternatively, timeline element 615 may display a time window within the time period of viewing history timeline screen 610 (e.g., 6 hours). User interface 600 may be configured to display a rolling or sliding timeline element 615, so that a user can navigate and up and down the timeline to focus user interface 600 on a desired time window within the default period.

As illustrated in FIG. 6, content marker 620-1 may cover a period from 7:05 PM to 7:31 PM and may include a viewing content designation of “Entertainment Tonight—Channel 404.” Content marker 620-2 may cover 7:32 PM to 7:58 PM and may include a viewing content designation of “College Basketball—Channel 410.” Content marker 620-3 may cover 7:59 PM to 8:10 PM and may include a viewing content designation of “Pre-Season Baseball—Channel 411.” Content marker 620-4 may cover 8:11 PM to 8:57 PM and may include a viewing content designation of “College Basketball—Channel 410.” Content marker 620-5 may cover 8:58 PM to 10:00 PM and may include a viewing content designation of “24—Channel 405.” Content marker 620-6 may cover 10:01 PM to 11:00 PM and may include a viewing content designation of “Fox 5 News—Channel 405.” Content marker 620-7 may cover 11:01 PM to 11:35 PM and may include a viewing content designation of “SportsCenter—Channel 410.” As described above, metadata capture logic 310 may be configured to ignore content viewed for less than a predetermined threshold (e.g., 5-10 minutes).

User interface 600 may also be configured to enable a user to request additional information relating to any of content markers 620, e.g., in a drill-down manner. For example, STB 120 may receive commands from a remote control (e.g., remote control 130) associated therewith, to navigate to and select content marker 620-4 on timeline element 615. Selection of content marker 620-4 may result in user interface 600 displaying additional details (e.g., on a new screen, in a pop-up element, etc.) regarding content marker 620-4, such as specific information regarding the content viewed, times viewed, etc.

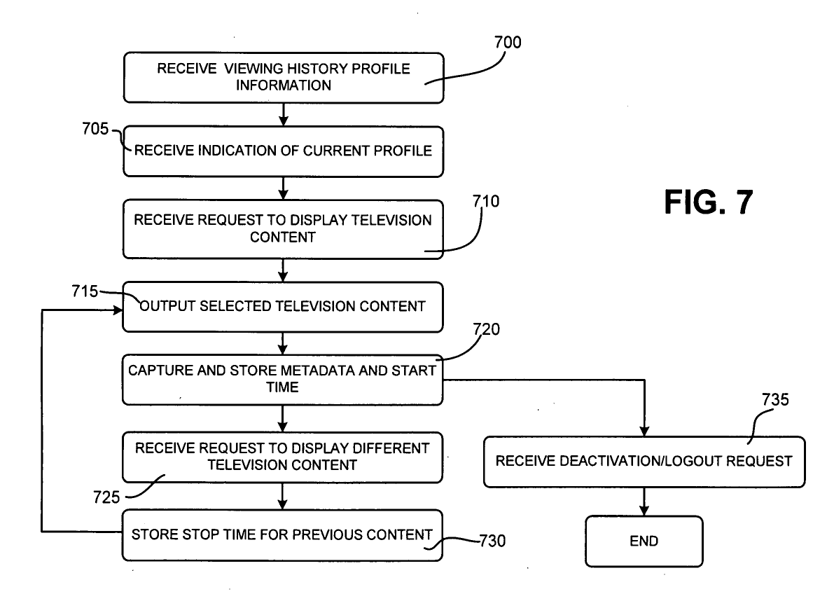

FIG. 7 is a flow diagram illustrating exemplary processing associated with the television content viewing history system of FIG. 3. Processing may begin with STB 120 (and/or television 110) (e.g., profile logic 300) receiving viewing history profile information (block 700), e.g., from an authorized user associated with STB 120. As described above, exemplary viewing history profile information may include login information for various users of STB 120. For example, the children in a family may be assigned to a “kids” profile, the adults may be assigned to an “adults” profile, and family viewing may be assigned to a “family” profile. In additional implementations, profiles may be associated with individuals, e.g., Mom, Dad, daughter, Grandma, etc. Although it is envisioned that viewing profiles may be used for other purposes, such as channel/time restrictions, content preferences, program guide preferences, etc., for the purposes of this description, profiles may be established to facilitate subsequent review of viewing history associated with the profiles.

Once a profile has been established, STB 120 may receive an indication of a current viewer profile (block 705). For example, a child in the family may turn on STB 120 (or television 110) and may indicate (e.g., via remote control 130 and on-screen display) that they are a member of the “kids” profile. In some implementations, each profile may be associated with login information, such as a password or PIN (personal identification number), for entry upon activating STB 120. In this manner, it may be ensured that only members of a particular profile sign on to STB 120 using that profile.

STB 120 may receive a request to display television content (block 710). For example, STB 120 may receive a channel number (e.g., via remote control 130). Alternatively, as described above, STB 120 may receive a request to display a program guide, may display the current program guide, and may subsequently receive a selection of television content via user interaction with the program guide. In yet another implementation, STB 120 may receive a request for a listing of previously recorded television content or VOD offerings, and may subsequently receive a selection of television content via user interaction with the listing of previously recorded television content or VOD offerings. In still another implementation, STB 120 may receive a request for activation of a selected widget application.

STB 120 may output the selected television content for viewing (block 715). For example, STB 120 may output the selected television content via television 110. STB 120 (e.g., metadata capture logic 310) may capture and store metadata corresponding to the selected television content (block 720). For example, as described above, metadata capture logic 310 may capture program guide information corresponding to the selected television content and store the capture information in, e.g., a database, such as database 400 in content memory 320. In addition to the program guide information, metadata capture logic 310 may also store a start time associated with the time at which STB 120 output the content for viewing.

STB 120 may receive a request to display different television content (block 725). The request to display different television content may be received in a substantially similar manner as block 710 described above. STB 120 may store the stop time associated with the previous television content, e.g., in the database entry (block 730). Processing may then return to block 715 for outputting and storing information associated with the different television content.

As an option to viewing different television content (from block 720), STB 120 may receive a request to deactivate or turn off STB 120 or television 110 (block 735). Alternatively, STB 120 may receive a request to log out of the current profile. In response to such a selection, STB may store the stop time associated with the previous television content, e.g., in the appropriate database entry 405.

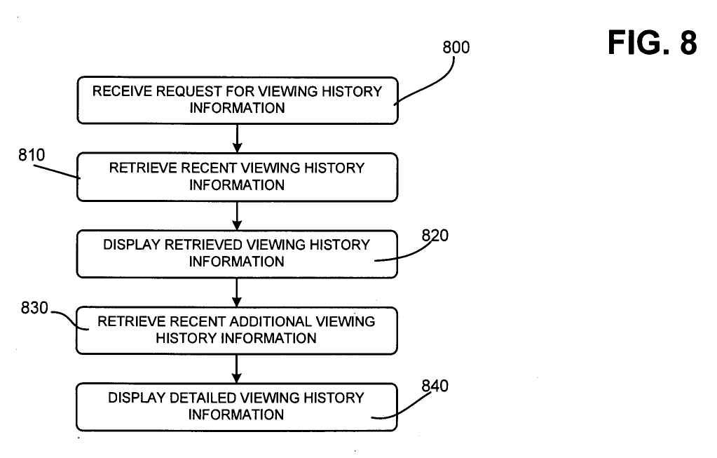

FIG. 8 is a flow diagram illustrating additional exemplary processing associated with the television content viewing history system of FIG. 1. Processing may begin with STB 120 receiving a request for viewing history information (block 800). In one implementation, a viewing history information option may be provided in a menu of choices available to a user of STB 120. As described briefly above, certain users (e.g., household adults, account holders, etc.) may be authorized to review viewing history information for more than one profile associated with STB 120. In this manner, menu choices available to users may be dynamically modified to reflect the choices available based on the profile under which the user signed into or logged into STB 120. In one implementation, the request for viewing history information may designate a particular profile. In other implementations, viewing history information for all profiles associated with the user may be made available.

In response to the receipt of the viewing history information request, STB 120 (e.g., history reporting logic 330) may retrieve recent viewing history information (e.g., from content memory 320) associated with the profile (or profiles) relating to the requesting user (block 810). In one implementation, history reporting logic 330 may be configured to provide viewing history information for a default or predetermined time interval. In other implementations, prior to retrieving the recent viewing history information, history reporting logic 330 may query the user for a time interval to review.

History reporting logic 330 may display the retrieved recent viewing history information to the user (block 820). As described above, viewing history information may be displayed in a variety of manners based on user preferences, default settings, explicit requests, etc. For example, history reporting logic 330 may be configured to initially provide a viewing history overview screen 510, such as viewing history overview screen 510 illustrated in FIG. 5. The viewing history overview screen may provide a high-level breakdown of the viewing history associated with the profile or profiles relating to the user. For example, the viewing history overview screen may textually or graphically (e.g., via charts, graphs, icons, etc.) illustrate a percentage of time spent viewing various types of viewing content during the defined time interval. During account setup or as a preference setting in STB 120, the user may specify the default format of the viewing history overview screen as based on content type, content genre, content rating, etc. Furthermore, as discussed above, the viewing history information may be presented in a timeline format, such as that depicted in FIG. 6.

History reporting logic 330 may receive a request for additional viewing history information (block 830). As described above, history reporting logic 330 may enable the user to navigate to and select one or more elements displayed on the viewing history overview screen. For example, the user may select an element indicating that 50% of the viewed content was VOD offerings. In response to such a request, history reporting logic 330 may display detailed viewing history corresponding to the selected element (block 840). For example, the display may show percentage of time watching a particular show, full description information associated with a show (e.g., rating, actors, synopsis, etc.). In addition, the display may show recommended shows suggested by recommendation engine 340, based on viewing of the selected element.

Implementations described herein relate to devices, methods, and systems for facilitating the storing and review of viewing history information. In some implementations, a STB or television may include components configured to capture metadata associated with viewed television content. Upon subsequent request, the captured metadata may be retrieved and presented to a user in a number of different formats.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, various features have been mainly described above with respect to a STB or television performing metadata capture and history reporting functions. In other implementations, features described herein may be implemented mainly in one or more devices remote from the STB or television, such as by a remote server application (such as service provider 140).

Further, while series of blocks have been described with respect to FIG. 7-8, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
capturing descriptive information associated with viewed television content;
storing the captured information;
receiving a request to display viewing history information;
retrieving at least some of the captured information; and
displaying the retrieved information.

2. The method of claim 1, further comprising:
establishing a profile associated with at least one television viewer;
determining that the profile is active;
associating the captured information with the profile; and
storing the captured information.

3. The method of claim 1, wherein determining that the profile is active comprises receiving log in information associated with the profile.

4. The method of claim 1, wherein the information associated with viewed television content comprises metadata corresponding to television content displayed on a display device,
wherein the metadata includes at least time information and descriptive information, the time information comprising date information, a start viewing time, and a stop viewing time.

5. The method of claim 4, further comprising:
disregarding the captured information when it is determined that the stop viewing time is within a threshold amount of the start viewing time.

6. The method of claim 4, wherein the metadata further includes at least one of title information, channel information, content type information, genre information, rating information, video format information, actor information, director information, or producer information.

7. The method of claim 6, further comprising:
obtaining program guide information corresponding to available content; and
capturing the information associated with the viewed television content from the obtained program guide information.

8. The method of claim 1, further comprising:
determining whether the request to display viewing history information is received from an authorized user; and
retrieving and displaying at least some of the captured information when the request to display viewing history information is received from an authorized user.

9. The method of claim 8, wherein the authorized user is an account holder associated with a device used to view the television content.

10. The method of claim 1, wherein the request to display viewing history information designates a viewing history time period associated with the request.

11. The method of claim 10, wherein the time period is a default time period.

12. The method of claim 10, wherein displaying the captured information further comprises:
displaying a timeline element corresponding to the viewing history time period; and
displaying a content marker on the timeline element, wherein the content marker is associated with the television content viewed during the viewing history time period.

13. The method of claim 12, wherein the viewed television content comprises more than one television program viewed during the viewing history time period, the method further comprising:
displaying more than one content marker on the timeline element, the more than one content marker corresponding to the more than one television program viewed during the viewing history time period.

14. The method of claim 1, wherein storing the captured information further comprises storing the captured information on a device remote from a device used to view the television content, and
wherein the request to display viewing history information is received at the remote device.

15. The method of claim 14, wherein the device used to view the television content comprises a set-top box (STB).

16. A device, comprising:
a communication interface configured to receive television content,
wherein the communication interface is further configured to receive descriptive information relating to the television content;
a memory to store at least some of the descriptive information relating to the television content;
an output interface for displaying selected elements of the received television content; and
logic configured to:
receive a request to display a first selected element of the received television content;
output the first selected element of received television content on the output interface; and
store information associated with the first selected element of the received television content in the memory,
wherein the stored information comprises descriptive information associated with the first selected element of the received television content and time information corresponding to a start time of the output.

17. The device of claim 16, wherein the information associated with the first selected element of the received television content is stored as a content viewing entry in a database in the memory.

18. The device of claim 16, wherein the first selected element of received television content comprises live television content, recorded television content, on-demand television content, games content, or widgets content.

19. The device of claim 16, wherein the logic is further configured to:
receive a request to display a second selected element of the received television content that is different than the first selected element;
store a stop time associated with the request to display the second selected element with the information associated with the first selected element of the received television content;
output the second selected element on the output interface; and
store information associated with the second selected element in the memory, including a start time of the output of the second selected element.

20. The device of claim 19, wherein the logic is further configured to:
receive a request to display viewing history information;
retrieve the stored information associated the captured first selected element of the received television content; and
output overview viewing history information based on at least some of the stored information on the output interface.

21. The device of claim 19, wherein the request to display viewing history information designates a viewing history time period associated with the request.

22. The device of claim 21, wherein the logic configured to output the overview viewing history information is further configured to:
output a viewing history interface that includes:
a timeline element corresponding to the viewing history time period; and
a content marker on the timeline element, wherein the content marker is associated with the first selected element during the viewing history time period.

23. A computer-readable medium having stored thereon sequences of instructions which, when executed by at least one processor, cause the at least one processor to:
receive television content, the television content having a number of content programs provided therein,
receive a request to view a selected content program from the number of content programs;
capture descriptive information associated with selected content program,
wherein the captured information includes a start time and a stop time associated with the viewing;
store the captured information;
receive a request to display viewing history information;
retrieve the captured information; and
display at least some of the captured information.

24. The computer-readable medium of claim 23, further including instructions for causing the at least one processor to:
establish a profile associated with at least one television viewer;
determine that the profile is active;
associate the captured information with the profile; and
store the captured information.

25. The computer-readable medium of claim 23, wherein the instructions for storing the captured information further comprise instructions for causing the at least one processor to store the captured information on a device remote from a device used to view the television content, and
wherein the request to display viewing history information is received at the remote device.
